(19) United States
(12) Patent Application Publication
(10) Pub. No.: US 2023/0167569 A1
(43) Pub. Date: Jun. 1, 2023

(54) CO3O4 NANOSHEET LOADED STAINLESS STEEL MESH, PREPARATION METHOD AND APPLICATION THEREOF

(71) Applicant: XI'AN UNIVERSITY OF ARCHITECTURE AND TECHNOLOGY, Xi'an (CN)

(72) Inventors: Xiaohu REN, Xi'an (CN); Shanshan CUI, Xi'an (CN); Hongfeng YIN, Xi'an (CN); Chunli YANG, Xi'an (CN); Hudie YUAN, Xi'an (CN)

(21) Appl. No.: 17/965,156

(22) Filed: Oct. 13, 2022

(30) Foreign Application Priority Data
Nov. 30, 2021 (CN) 2021114508029

(51) Int. Cl. C25D 9/10; C23G 1/08; C23G 5/024; F22B 1/00

(52) U.S. Cl. CPC C25D 9/10; C23G 1/08; C23G 5/024; F22B 1/006

(57) ABSTRACT

Disclosed are a Co₃O₄ nanosheet loaded stainless steel mesh, a preparation method and an application thereof. The method includes: S1, depositing a cobalt hydroxide nanosheet array on a surface of a stainless steel mesh by an electrochemical deposition method, and obtaining the stainless steel mesh deposited with the cobalt hydroxide nanosheet array; and S2, obtaining the Co₃O₄ nanosheet loaded stainless steel mesh by calcining the stainless steel mesh deposited with the cobalt hydroxide nanosheet array.

### CROSS-REFERENCE TO RELATED APPLICATIONS

This application claims priority to Chinese Patent Application No. 202111450802.9, filed on Nov. 30, 2021, the contents of which are hereby incorporated by reference.

### TECHNICAL FIELD

The application belongs to the technical field of photothermal conversion materials, and in particular relates to a Co₃O₄ nanosheet loaded stainless steel mesh, a preparation method and an application thereof.

### BACKGROUND

With a rapid increase of population on the earth and a rapid development of an industrial production, a shortage of fresh water resources has become one of global crises facing mankind. At present, 9% of the world's population has no access to safe freshwater resources, and 29% of the world's population has no access to safe drinking water. According to statistics of the World Health Organization, by 2025, half of the world's population will live in areas with a water shortage. Although ⅔ of the earth's surface is covered by water, 97% of the water is undrinkable seawater; therefore, how to desalinate seawater conveniently and efficiently has aroused a widespread interest of researchers.

Commonly used seawater desalination technologies mainly include reverse osmosis, freezing, electrodialysis and distillation, etc. But at present, these methods still consume non-renewable fossil energy directly or indirectly. Although these technologies may alleviate a freshwater crisis to a certain extent, these technologies are also accompanied by an environmental pollution and a greenhouse effect. Using solar energy to convert heat energy to realize a water evaporation desalination may effectively avoid the above problems, and it is a very effective and feasible technology for a seawater desalination. Therefore, an interfacial solar water evaporation is considered as a promising seawater desalination technology. Since an evaporation of water only occurs on the surface of water, to achieve a high efficiency of a water vapor generation, it is necessary to rely on photothermal conversion materials to gather heat at an air-water interface. Therefore, it is of great significance to study the photothermal conversion materials with an excellent performance for a development of a photothermal-driven seawater desalination.

At present, common photothermal conversion materials that utilize sunlight include carbon-based materials, metal-based nanoparticles, organic polymers, inorganic semiconductor materials, etc. Nano-metal ion plasma has a good photothermal conversion performance, but a high cost and a poor corrosion resistance limit a large-scale application of the nano-metal ion plasma. Carbon-based materials have advantages of a wide absorption band and a good corrosion resistance, but their evaporation rate is not high because of a low photothermal conversion efficiency. The inorganic semiconductor materials have become a new research hotspot in the photothermal conversion materials because of a wide variety, a low cost and an easy functionalization. However, the existing inorganic semiconductor materials are mainly prepared by a sol-gel method, a hydrothermal method and a chemical vapor deposition method, and these methods generally have the problems of a long preparation period, a high cost and a difficulty in a large-scale preparation.

### SUMMARY

Aiming at technical problems existing in the prior art, the application provides a Co₃O₄ nanosheet loaded stainless steel mesh, a preparation method and an application thereof, so as to solve the technical problems of a low photothermal conversion efficiency, a complex preparation process and a high cost of traditional photothermal conversion materials.

In order to achieve the above objective, a technical scheme adopted by the application is as follows:

the application provides a preparation method of a Co₃O₄ nanosheet loaded stainless steel mesh, including following steps:

S1, depositing a cobalt hydroxide nanosheet array on a surface of a stainless steel mesh by an electrochemical deposition method, and obtaining the stainless steel mesh deposited with the cobalt hydroxide nanosheet array; and

S2, obtaining the Co₃O₄ nanosheet loaded stainless steel mesh by calcining the stainless steel mesh deposited with the cobalt hydroxide nanosheet array.

In an embodiment, in the S1, the stainless steel mesh is a 304 stainless steel mesh, and meshes per square centimetres of the stainless steel mesh are 120-400 meshes.

In an embodiment, in the S1, a process of depositing the cobalt hydroxide nanosheet array on the surface of the stainless steel mesh by the electrochemical deposition method is as follows:

depositing the cobalt hydroxide nanosheet array on the surface of the stainless steel mesh by a potentiostatic electrochemical deposition method in a three-electrode system;

after an electrolytic deposition reaction is finished, cleaning and drying the stainless steel mesh, and obtaining the stainless steel mesh deposited with the cobalt hydroxide nanosheet array; and

an electrolyte is formed by dissolving cobalt nitrate hexahydrate and nitrate in water and fully stirring; the stainless steel mesh is taken as a working electrode, a Pt sheet is taken as a counter electrode, and a saturated calomel electrode is taken as an reference electrode; a temperature in an electrolytic bath is kept at 20-30° C.; and the nitrate is sodium nitrate or potassium nitrate.

In an embodiment, a cathodic electrodeposition is adopted, a reaction voltage is 1.5-2 V, and a reaction duration is 2-5 minutes.

In an embodiment, a concentration of cobalt nitrate hexahydrate is 0.8-1.2 mol/L in the electrolyte, and the concentration of sodium nitrate or potassium nitrate is 0.05-0.1 mol/L.

In an embodiment, in the S1, before depositing the cobalt hydroxide nanosheet array on the surface of the stainless steel mesh by the electrochemical deposition method, cleaning pretreatment steps for the stainless steel mesh are also included;

the cleaning pretreatment steps for the stainless steel mesh are as follows:

immersing the stainless steel mesh in acetone, removing organic impurities on the surface of the stainless steel mesh by an ultrasonic cleaning, and obtaining the stainless steel mesh with the organic impurities removed;

soaking the stainless steel mesh with the organic impurities removed in a hydrochloric acid solution, and removing oxide impurities on the surface of the stainless steel mesh by the ultrasonic cleaning, and obtaining the stainless steel mesh with the oxide removed;

cleaning the stainless steel mesh with the oxide removed until a cleaning solution is neutral, and obtaining the stainless steel mesh after an impurity removal; and

immersing the stainless steel mesh after the impurity removal into absolute ethanol for an ultrasonic treatment, and drying to obtain the cleaned and pretreated stainless steel mesh.

In an embodiment, in the process of removing the organic impurities on the surface of the stainless steel mesh, a power of the ultrasonic cleaning is 100 W-120 W, and a duration is 20-30 minutes; and

in the process of removing the oxide impurities on the surface of the stainless steel mesh, a mass concentration of the hydrochloric acid solution is 3%-8%, the power of the ultrasonic cleaning is 100 W-120 W, and the duration is 10-20 minutes.

In the process of immersing the stainless steel mesh after the impurity removal into absolute ethanol for the ultrasonic treatment, an ultrasonic power is 80 W-100 W and the duration is 10-20 minutes; a drying process is carried out in a vacuum drying oven, with a drying temperature of 60-80° C. and a drying duration of 2-6 hours.

In an embodiment, the process of obtaining the Co₃O₄ nanosheet loaded stainless steel mesh by calcining the stainless steel mesh deposited with the cobalt hydroxide nanosheet array is as follows:

placing the stainless steel mesh deposited with the cobalt hydroxide nanosheet array in a muffle furnace, and calcining at 300-500° C. for 1-4 hours.

The application also provides a Co₃O₄ nanosheet loaded stainless steel mesh, and the Co₃O₄ nanosheet loaded stainless steel mesh is prepared by the preparation method of the Co₃O₄ nanosheet loaded stainless steel mesh.

The application also provides an application of the Co₃O₄ nanosheet loaded stainless steel mesh in a process of solar steam generation.

Compared with the prior art, the application has advantages that:

the application provides the Co₃O₄ nanosheet loaded stainless steel mesh, the preparation method and the application thereof; the cobalt hydroxide nanosheet array is deposited on the surface of the stainless steel mesh by the electrodeposition, and the Co₃O₄ nanosheet loaded stainless steel mesh is obtained by the calcination; Co₃O₄ not only absorbs solar energy efficiently, but also conducts converted heat energy out in times with excellent photothermal conversion characteristics and a good thermal conductivity; meanwhile, a nanosheet structure may increase a contact area with water, thus improving a steam generation efficiency; compared with the existing photothermal materials, Co₃O₄ has a high water evaporation efficiency, a good stability, a simple preparation method, a low cost and an easy scale production.

In an embodiment, a crystallinity of grown Co₃O₄ nanomaterials may be controlled by controlling a calcination temperature, so as to facilitate an optimization and obtain Co₃O₄ with a high photothermal conversion performance and the high thermal conductivity.

In an embodiment, the stainless steel mesh is not only a carrier for growing the Co₃O₄ nanosheets, but a porous structure helps more and more effective Co₃O₄ nanosheets to participate in the solar steam generation as photothermal conversion materials, so as to improve an ability of the materials to absorb sunlight and enhance a conversion efficiency of solar energy.

In an embodiment, Co₃O₄ nanosheets prepared by the electrochemical deposition method have a large number of micropores, so water is effectively transported to a gas-liquid interface by a capillary action to supply water for a steam generation; therefore, the Co₃O₄ nanosheets are super hydrophilic to ensure an evaporation rate and a smooth escape of water vapor.

### BRIEF DESCRIPTION OF THE DRAWINGS

FIG. 1 is a scanning electron microscope (SEM) of a Co₃O₄ nanosheet loaded stainless steel mesh prepared in Embodiment 1 at 100 times.

FIG. 2 is a scanning electron microscope (SEM) of a Co₃O₄ nanosheet loaded stainless steel mesh prepared in Embodiment 1 at 1000 times.

FIG. 3 is a scanning electron microscope (SEM) of a Co₃O₄ nanosheet loaded stainless steel mesh prepared in Embodiment 1 at 10,000 times.

FIG. 4 is a scanning electron microscope (SEM) of a Co₃O₄ nanosheet loaded stainless steel mesh prepared in Embodiment 1 at 50,000 times.

FIG. 5 is an XRD spectrum of Co₃O₄ nanosheets prepared in Embodiment 1.

FIG. 6 is a curve of surface temperature changes of stainless steel meshes loaded with and without Co₃O₄ nanosheets under simulated light conditions.

FIG. 7 is a curve of water evaporation quality changing with time when irradiated with a light intensity of 1 kW/m² for 60 minutes.

### DETAILED DESCRIPTION OF THE EMBODIMENTS

In order to make technical problems, technical schemes and beneficial effects solved by the application clearer, following specific embodiments further explain the application in detail. It should be understood that the specific embodiments described here are only for explaining the application, but not for limiting the application.

The application provides a preparation method of a Co₃O₄ nanosheet loaded stainless steel mesh, which specifically includes following steps:

S1, pretreating a stainless steel mesh;

S11, taking a 304 stainless steel mesh of 120-400 meshes, and cutting the stainless steel mesh into a square structure of 40 mm×40 mm;

S12, immersing the square stainless steel mesh in the S11 in acetone, removing organic impurities on a surface of the stainless steel mesh by an ultrasonic cleaning to obtain the stainless steel mesh with the organic impurities removed; and an ultrasonic cleaning duration is 20-30 minutes, and an ultrasonic power is 100-120 W;

S13, immersing the stainless steel mesh with the organic impurities removed into a hydrochloric acid solution, and removing oxide impurities on the surface of the stainless steel mesh by the ultrasonic cleaning to obtain the stainless steel mesh with the oxide removed; and a mass concentration of the hydrochloric acid solution is 3%-8%, a power of the ultrasonic cleaning is 100 W-120 W, and the duration is 10-20 minutes;

S14, cleaning a red copper mesh with the oxide removed by using deionized water until a cleaning solution is neutral, and obtaining the stainless steel mesh after an impurity removal; and

S15, immersing the stainless steel mesh after the impurity removal in absolute ethanol, and performing an ultrasonic treatment for 10-20 minutes under a condition of the ultrasonic power of 80 W-100 W; then, placing the red copper mesh after the ultrasonic cleaning in a vacuum drying oven with a drying temperature of 60-80° C. and a drying duration of 2-6 hours, and obtaining the stainless steel mesh after a cleaning pretreatment;

S2, electrochemical deposition:

forming an electrolyte by dissolving cobalt nitrate hexahydrate and nitrate in deionized water and fully stirring, where a concentration of cobalt nitrate hexahydrate in the electrolyte is 0.8-1.2 mol/L, and the concentration of the nitrate is 0.05-0.1 mol/L, and the nitrate is sodium nitrate or potassium nitrate;

using the stainless steel mesh as a working electrode, a Pt sheet as a counter electrode and a saturated calomel electrode (SCE) as a reference electrode in a three-electrode system; adopting a cathodic electrodeposition, keeping an electrolytic bath at 20-30° C. with a constant voltage of 1.5-2 V, and reacting for 2-5 minutes to deposit a cobalt hydroxide nanosheet array on the surface of the stainless steel mesh;

washing the reacted stainless steel mesh with distilled water for 3-5 times, and then washing the reacted stainless steel mesh with absolute ethanol for 3-5 times; then, blow-drying with a blower to obtain the stainless steel mesh deposited with the cobalt hydroxide nanosheet array; and

3, calcining;

placing the stainless steel mesh deposited with the cobalt hydroxide nanosheet array in a muffle furnace, and calcining for 1-4 hours at a calcination temperature of 300-500° C.;

taking out the stainless steel mesh after a furnace cooling to obtain the Co₃O₄ nanosheet loaded stainless steel mesh; among them, a heating rate in a calcination process is 2° C./min.

According to the preparation method of the Co₃O₄ nanosheet loaded stainless steel mesh, a stainless steel mesh material loaded with the Co₃O₄ nanosheet with a photothermal conversion performance is synthesized by a simple electrodeposition-calcination two-step method, and is used for a solar photothermal steam generation process, and provides a simple and feasible method for efficiently absorbing and utilizing solar energy to realize a seawater desalination; firstly, a crystallinity of grown Co₃O₄ nanomaterials may be controlled by controlling the calcination temperature, so as to facilitate an optimization and obtain Co₃O₄ with a high photothermal conversion performance and a high thermal conductivity; secondly, the stainless steel mesh is not only a carrier for growing the Co₃O₄ nanosheets, but a porous structure helps more and more effective Co₃O₄ nanosheets to participate in the solar steam generation as photothermal conversion materials, so as to improve an ability of the materials to absorb sunlight and enhance a conversion efficiency of solar energy; thirdly, the Co₃O₄ nanosheets have a large number of micropores under optimal conditions, so water is effectively transported to a gas-liquid interface by a capillary action to supply water for steam generation; therefore, the Co₃O₄ nanosheets are super hydrophilic to ensure an evaporation rate and a smooth escape of water vapor; and fourthly, the proposed Co₃O₄ nanosheets have a simple synthesis process, a short synthesis cycle, a strong controllability and a low cost, and are suitable for an industrial scale production, so the proposed Co₃O₄ nanosheets have a great practical development and utilization value.

An application of the Co₃O₄ nanosheet loaded stainless steel mesh in a process of solar water vapor generation provides a simple and feasible method for efficiently absorbing and utilizing the solar energy to realize the seawater desalination. The Co₃O₄ nanosheet loaded stainless steel mesh may be used as the photothermal converter material to participate in the solar water vapor generation, being beneficial to improving the ability of the materials to absorb sunlight and enhancing the conversion efficiency of solar energy.

### Embodiment 1

Embodiment 1 provides a preparation method of a Co₃O₄ nanosheet loaded stainless steel mesh, which specifically includes the following steps:

S1, pretreating a stainless steel mesh;

S11, taking a 304 stainless steel mesh of 120 meshes, and cutting the stainless steel mesh into a square structure of 40 mm×40 mm;

S12, immersing the square stainless steel mesh in the S11 in acetone, removing organic impurities on a surface of the stainless steel mesh by an ultrasonic cleaning to obtain the stainless steel mesh with the organic impurities removed; and an ultrasonic cleaning duration is 30 minutes, and an ultrasonic power is 100 W;

S13, immersing the stainless steel mesh with the organic impurities removed into a 3% hydrochloric acid solution, and removing oxide impurities on the surface of the stainless steel mesh by the ultrasonic cleaning to obtain the stainless steel mesh with the oxide removed; and a power of the ultrasonic cleaning is 100 W, and the duration is 20 minutes;

S14, cleaning a red copper mesh with the oxide removed by using deionized water until a cleaning solution is neutral, and obtaining the stainless steel mesh after an impurity removal; and

S15, immersing the stainless steel mesh after the impurity removal in absolute ethanol, and performing an ultrasonic treatment for 10 minutes under a condition of the ultrasonic power of 100 W; then, placing the red copper mesh after the ultrasonic cleaning in a vacuum drying oven with a drying temperature of 60° C. and a drying duration of 2 hours, and obtaining a stainless steel mesh after a cleaning pretreatment;

S2, electrochemical deposition method:

forming an electrolyte by dissolving 52.395 g cobalt nitrate hexahydrate and 1.275 g sodium nitrate in deionized water and fully stirring, where a concentration of cobalt nitrate hexahydrate in the electrolyte is 0.8-1.2 mol/L, and the concentration of the sodium nitrate is 0.05-0.1 mol/L;

using the stainless steel mesh as a working electrode, a Pt sheet as a counter electrode and a saturated calomel electrode (SCE) as a reference electrode in a three-electrode system; adopting a cathodic electrodeposition, keeping an electrolytic bath at 20-30° C. with a constant voltage of 1.5 V, and reacting for 2 minutes to deposit a cobalt hydroxide nanosheet array on the surface of the stainless steel mesh;

washing the reacted stainless steel mesh with distilled water for 5 times, and then washing the reacted stainless steel mesh with absolute ethanol for 3 times; then, blow-drying with a blower to obtain the stainless steel mesh deposited with the cobalt hydroxide nanosheet array; and

3, calcining;

placing the stainless steel mesh deposited with the cobalt hydroxide nanosheet array in a muffle furnace, and calcining for 2 hours at a calcination temperature of 350° C.; taking out the stainless steel mesh after a furnace cooling to obtain a Co₃O₄ nanosheet loaded stainless steel mesh; among them, a heating rate in a calcination process is 2° C./min.

The Co₃O₄ nanosheet loaded stainless steel mesh obtained in Embodiment 1 is characterized and is subjected to a performance measurement. Measurement results are as follows.

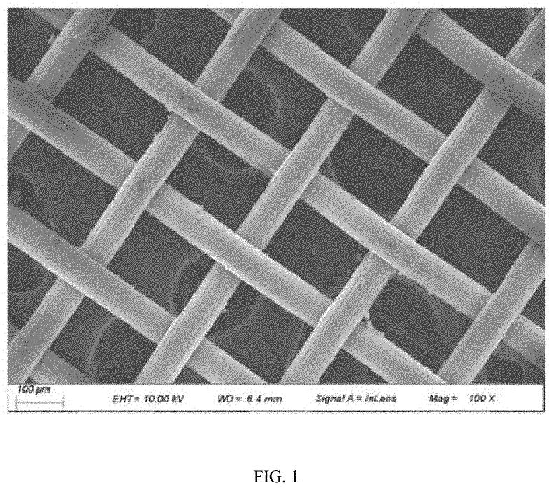

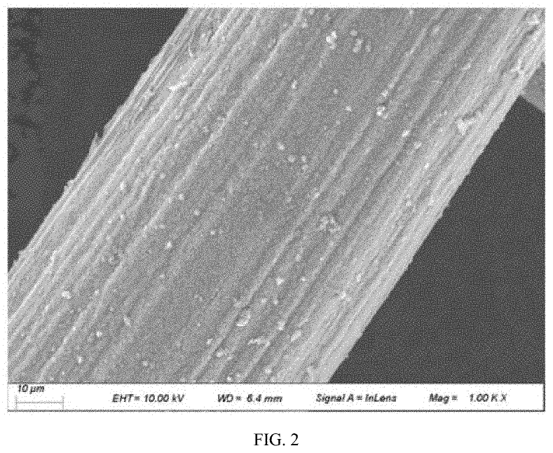

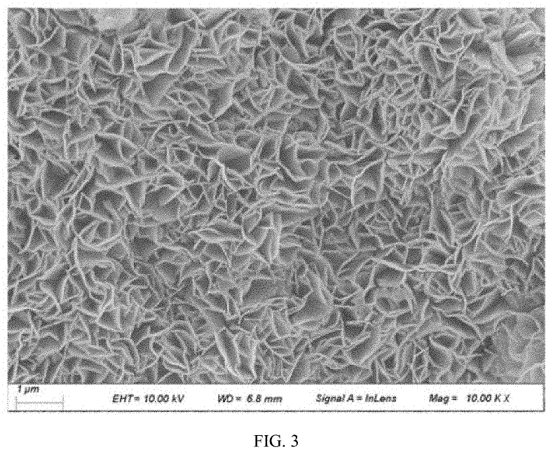

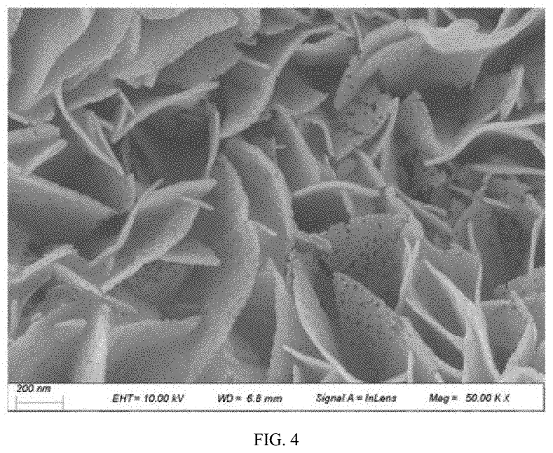

As shown in FIGS. 1-4, FIG. 1 shows a scanning electron microscope (SEM) image of a Co₃O₄ nanosheet loaded stainless steel mesh prepared in Embodiment 1 at 100 times, FIG. 2 shows the SEM image of the Co₃O₄ nanosheet loaded stainless steel mesh prepared in Embodiment 1 at 1000 times, and FIG. 3 shows the SEM image of the Co₃O₄ nanosheet loaded stainless steel mesh prepared in Embodiment 1 at 10000 times; FIG. 4 shows the SEM image of the Co₃O₄ nanosheet loaded stainless steel mesh prepared in Embodiment 1 at 50,000 times; as can be seen from FIG. 1, a mesh structure of the stainless steel mesh has an aperture of about 100 μm, and the evenly distributed meshes are conducive to a smooth precipitation of water vapor through the copper mesh; as can be seen from FIG. 2, there is a layer of dense porous materials on the surface of the stainless steel mesh, indicating that the method described above may uniformly and completely grow Co₃O₄ nanosheets on the surface of the stainless steel mesh; as can be seen from FIGS. 3 and 4, a dense nanosheet array grows on the surface of stainless steel mesh, and there are abundant micropores on the nanosheet; the three-dimensional nanosheet array and a micropore structure have a high specific surface area, so a light shining on the surface of the material has a strong diffuse reflection, an interaction between Co₃O₄ and light is promoted, thus enhancing an absorption of light.

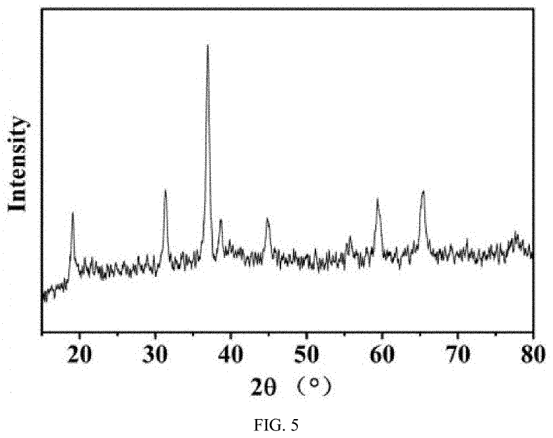

As shown in FIG. 5, an X-ray diffraction (XRD) pattern of Co₃O₄ nanosheets deposited on the stainless steel mesh prepared in Embodiment 1 is shown in FIG. 5; as can be seen from FIG. 5, the nanosheets produced are spinel-type Co₃O₄ phase (PDF card: JCPDS No. 43-1003); this analysis confirms that precursors deposited on a stainless steel substrate are calcined at 350° C. to produce Co₃O₄ nanosheets.

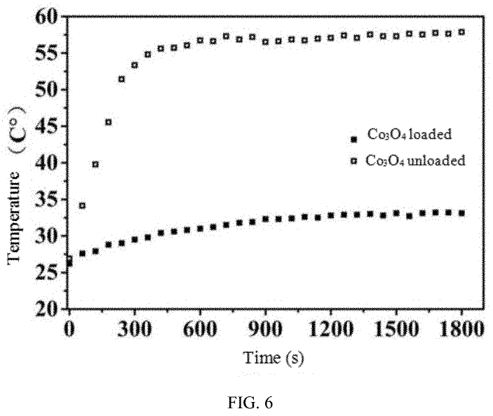

A surface temperature test of the Co₃O₄ nanosheet loaded stainless steel mesh obtained in Embodiment 1 and a pure stainless steel mesh is carried out under a light intensity of 1 kW/m²; the test results are shown in FIG. 6. It can be seen from FIG. 6 that the surface temperature of the pure stainless steel mesh is only about 32° C., while the surface temperature of the Co₃O₄ nanosheet loaded stainless steel mesh may reach 58° C., indicating that the loaded Co₃O₄ nanosheet has an excellent photothermal conversion performance.

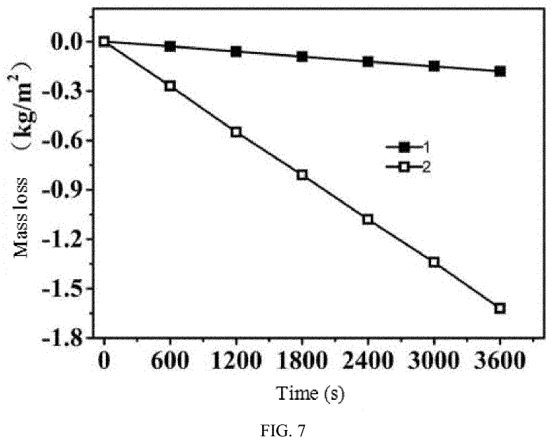

As shown in FIG. 7, a curve of water evaporation quality with time is given in FIG. 7 under the light intensity of 1 kW/m² for 60 minutes, where 1 represents water, and 2 represents Co₃O₄ nanosheet loaded stainless steel mesh prepared in Embodiment 1; it can be seen from FIG. 7 that an evaporation rate of water is 0.18 kgm⁻²·h⁻¹ under the light intensity of 1 kW/m², while the evaporation rate of water is 1.62 kg·m⁻²·h⁻¹ under an action of Co₃O₄ nanosheet loaded stainless steel mesh; compared with pure water, the Co₃O₄ nanosheet loaded stainless steel mesh prepared in Embodiment 1 obviously promotes the generation of water vapor driven by light and heat.

### Embodiment 2

A difference from Embodiment 1 is that: the aperture of the stainless steel mesh is adjusted to 200 meshes or 400 meshes according to the preparation method of Embodiment 1, and other conditions are unchanged; in the Co₃O₄ nanosheet loaded stainless steel mesh prepared in Embodiment 2, the Co₃O₄ nanosheets are pure spinel Co₃O₄, and a morphology is the same as that in FIG. 1, and the corresponding performance of the photothermal conversion stainless steel mesh obtained in Embodiment 1 may be achieved.

### Embodiment 3

The difference from Embodiment 1 is that: the concentrations of cobalt nitrate hexahydrate and sodium nitrate in the electrolyte are adjusted to 0.6 mol/L and 0.05 M mol/L according to the preparation method of Embodiment 1, and other conditions remain unchanged; in the Co₃O₄ nanosheet loaded stainless steel mesh prepared in Embodiment 3, the Co₃O₄ nanosheets are pure spinel Co₃O₄, and the morphology is the same as that in FIG. 1, and the corresponding performance of the photothermal conversion stainless steel mesh obtained in Embodiment 1 may be achieved.

### Embodiment 4

The difference from Embodiment 1 is that: the constant voltage is adjusted to 1.8 V or 2 V, the electrodeposition duration is adjusted to 3 minutes, 4 minutes or 5 minutes according to the preparation method of Embodiment 1, and other conditions are unchanged; in the Co₃O₄ nanosheet loaded stainless steel mesh prepared in Embodiment 4, the Co₃O₄ nanosheets are pure spinel Co₃O₄, the morphology is the same as that in FIG. 1, and the corresponding performance of the photothermal conversion stainless steel mesh obtained in Embodiment 1 may be achieved.

### Embodiment 5

The difference from Embodiment 1 is that: according to the preparation method of Embodiment 1, the calcination temperature is adjusted to 300° C., 400° C., 450° C. or 500° C., a holding duration is adjusted to 1 hour, 3 hours or 4 hours, and other conditions are unchanged; in the Co₃O₄ nanosheet loaded stainless steel mesh prepared in Embodiment 4, the Co₃O₄ nanosheets are pure spinel Co₃O₄, the morphology is the same as that in FIG. 1, and the corresponding performance of the photothermal conversion stainless steel mesh obtained in Embodiment 1 may be achieved.

Co₃O₄ is a narrow band-gap semiconductor, a band gap of Co₃O₄ is about 1.5 eV, and Co₃O₄ has a good light absorption performance in a visible light band. At the same time, Co₃O₄ has a high thermal conductivity; in the application, Co₃O₄ is prepared into a nanomaterial and used as a photothermal absorber, so Co₃O₄ may not only efficiently absorb the solar light energy, but also conduct the converted heat energy out in time; therefore, it is of great application value to develop a preparation technology of Co₃O₄ nanomaterials for the photothermal conversion.

The Co₃O₄ nanosheet loaded stainless steel mesh, the preparation method and the application thereof according to the application are used for a photo-thermal driving water vapor generation. After pretreating the stainless steel mesh, a layer of cobalt hydroxide nanosheet array is deposited on the surface of the steel mesh by the electrodeposition, and finally a Co₃O₄ nanosheet loaded stainless steel photothermal conversion mesh is obtained by the calcination. The excellent photothermal conversion characteristics and the good thermal conductivity of Co₃O₄ make the Co₃O₄ not only absorb solar energy efficiently, but also conduct the converted heat energy out in time. meanwhile, the nanosheet structure may increase a contact area with water, thus improving a steam generation efficiency. Compared with the existing photothermal materials, the material has a high water evaporation efficiency, a good stability, a simple preparation method, a low cost and an easy scale production.

The above-mentioned embodiment is only one of the embodiments that may realize technical schemes of the application, and a scope of the claimed protection of the application is not only limited by this embodiment, but also includes any changes, substitutions and other embodiments that may be easily thought of by those skilled in the technical field within the technical scope disclosed by the application.

What is claimed is:

1. A preparation method of a Co₃O₄ nanosheet loaded stainless steel mesh, comprising:
S1, depositing a cobalt hydroxide nanosheet array on a surface of a stainless steel mesh by an electrochemical deposition method, and obtaining the stainless steel mesh deposited with the cobalt hydroxide nanosheet array; and
S2, obtaining the Co₃O₄ nanosheet loaded stainless steel mesh by calcining the stainless steel mesh deposited with the cobalt hydroxide nanosheet array.

2. The preparation method of the Co₃O₄ nanosheet loaded stainless steel mesh according to claim 1, wherein in the S1, the stainless steel mesh is a 304 stainless steel mesh, and a mesh number of the stainless steel mesh is 120-400.

3. The preparation method of the Co₃O₄ nanosheet loaded stainless steel mesh according to claim 1, wherein in the S1, a process of depositing the cobalt hydroxide nanosheet array on the surface of the stainless steel mesh by the electrochemical deposition method is as follows:
depositing the cobalt hydroxide nanosheet array on the surface of the stainless steel mesh by a potentiostatic electrochemical deposition method in a three-electrode system;
after an electrolytic deposition reaction is finished, cleaning and drying the stainless steel mesh, and obtaining the stainless steel mesh deposited with the cobalt hydroxide nanosheet array; and
forming an electrolyte by dissolving cobalt nitrate hexahydrate and nitrate in water and fully stirring; wherein the stainless steel mesh is taken as a working electrode, a Pt sheet is taken as a counter electrode, and a saturated calomel electrode is taken as an reference electrode; a temperature in an electrolytic bath is kept at 20-30° C.; and the nitrate is sodium nitrate or potassium nitrate.

4. The preparation method of the Co₃O₄ nanosheet loaded stainless steel mesh according to claim 3, wherein a cathodic electrodeposition is adopted, a reaction voltage is 1.5-2 volts (V), and a reaction duration is 2-5 minutes.

5. The preparation method of the Co₃O₄ nanosheet loaded stainless steel mesh according to claim 3, wherein a concentration of cobalt nitrate hexahydrate is 0.8-1.2 mol/L in the electrolyte, and the concentration of sodium nitrate or potassium nitrate is 0.05-0.1 mol/L.

6. The preparation method of the Co₃O₄ nanosheet loaded stainless steel mesh according to claim 1, wherein in the S1, before depositing the cobalt hydroxide nanosheet array on the surface of the stainless steel mesh by the electrochemical deposition method, cleaning pretreatment steps for the stainless steel mesh are also included;
the cleaning pretreatment steps for the stainless steel mesh are as follows:
immersing the stainless steel mesh in acetone, removing organic impurities on the surface of the stainless steel mesh by an ultrasonic cleaning, and obtaining the stainless steel mesh with the organic impurities removed;
soaking the stainless steel mesh with the organic impurities removed in a hydrochloric acid solution, and removing oxide impurities on the surface of the stainless steel mesh by the ultrasonic cleaning, and obtaining the stainless steel mesh with the oxide removed;
cleaning the stainless steel mesh with the oxide removed until a cleaning solution is neutral, and obtaining the stainless steel mesh after an impurity removal; and
immersing the stainless steel mesh after the impurity removal into absolute ethanol for an ultrasonic treatment, and drying to obtain the cleaned and pretreated stainless steel mesh.

7. The preparation method of the Co₃O₄ nanosheet loaded stainless steel mesh according to claim 6, wherein in a process of removing the organic impurities on the surface of the stainless steel mesh, a power of the ultrasonic cleaning is 100 watt (W)-120 W, and a duration is 20-30 minutes;
in the process of removing the oxide impurities on the surface of the stainless steel mesh, a mass concentration of the hydrochloric acid solution is 3%-8%, the power of the ultrasonic cleaning is 100 W-120 W, and the duration is 10-20 minutes; and
in the process of immersing the stainless steel mesh after the impurity removal into absolute ethanol for the ultrasonic treatment, an ultrasonic power is 80 W-100 W and the duration is 10-20 minutes; a drying process is carried out in a vacuum drying oven, with a drying temperature of 60-80° C. and a drying duration of 2-6 hours.

8. The preparation method of the Co₃O₄ nanosheet loaded stainless steel mesh according to claim 1, wherein the process of obtaining the Co₃O₄ nanosheet loaded stainless steel mesh by calcining the stainless steel mesh deposited with the cobalt hydroxide nanosheet array is as follows:
placing the stainless steel mesh deposited with the cobalt hydroxide nanosheet array in a muffle furnace, and calcining at 300-500° C. for 1-4 hours.

9. A Co₃O₄ nanosheet loaded stainless steel mesh, wherein the Co₃O₄ nanosheet loaded stainless steel mesh is prepared by the preparation method of the Co₃O₄ nanosheet loaded stainless steel mesh according to claim 1.

10. An application of the Co₃O₄ nanosheet loaded stainless steel mesh according to claim 9 in a process of solar steam generation.
